(19) United States
(12) Patent Application Publication
(10) Pub. No.: US 2017/0187782 A1
(43) Pub. Date: Jun. 29, 2017

(54) TELEMETRY RESPONSE SYSTEM

(71) Applicant: Microsoft Technology Licensing, LLC, Redmond, WA (US)

(72) Inventors: Brian R. Crawford, Seattle, WA (US); Amy M. Lewis, Sammamish, WA (US); William M. Zintel, Woodinville, WA (US); Ravi C. Shahani, Bellevue, WA (US); Brian P. Ellis, Sammamish, WA (US); George Joy, Kirkland, WA (US); James O. Todd, Redmond, WA (US); Ken Ming-Kin Yip, Bellevue, WA (US); Mahmood G. Qadir, Redmond, WA (US); Mark E. Russinovich, Hunts Point, WA (US); Vitaliy Titov, Redmond, WA (US); Wojtek Kozaczynski, Duvall, WA (US); Tae Hyung Kim, Seoul (KR); Vito J. Sabella, Bellevue, WA (US); Christopher M. Lang, Bellevue, WA (US); Jonathan K. Johnson, Issaquah, WA (US)

(73) Assignee: Microsoft Technology Licensing, LLC, Redmond, WA (US)

(21) Appl. No.: 14/885,973

(22) Filed: Oct. 16, 2015

(51) Int. Cl. H04L 29/08; H04L 12/26; H04L 12/927; G08C 19/16

(52) U.S. Cl. CPC H04L 67/025; H04L 67/125; G08C 19/16; H04L 67/2823; H04L 43/04; H04L 47/803

(57) ABSTRACT

A method of operating a telemetry system includes receiving an automatically populated set of fields in a schema of an event definition, and providing a response message in an application protocol. The set of fields are automatically populated using a logging library of the telemetry system.

### BACKGROUND

In order to improve the quality of software applications, software developers attempt to understand how the applications perform in the hands of users including customers and clients. While laboratory or development testing, such as debugging and logging, during application development is important in improving quality, laboratory testing alone is seldom sufficient for many modern applications. Modern software applications, especially mobile applications, are highly interactive, and a full range of user interactions are difficult to simulate in a laboratory or during development. Also, a number of environmental conditions effect user experience with applications. For example, network connectivity, GPS-signal quality, and device hardware all vary widely. Some platform APIs can even change behavior depending on the amount of power left in the device battery. These diverse environmental conditions are difficult to reproduce in a laboratory. Thus, many software developers endeavor to collect diagnostic and performance trace data from the field.

Platform support for tracing application performance in the field, however, is typically inadequate. Major platforms, including mobile platforms, provide application crash logs to developers, but developers report difficulty in identifying the causes of crashes from many logs. Further, such data, which may also include unresponsive events and exceptions, does not provide much assistance in detecting performance issues. Analytics frameworks are designed to collect usage analytics such as user demographics rather than performance data. This information typically does not effectively provide information about specific user activity within the application.

Instead, developers that seek meaningful information regarding application performance will include custom tracing code in the application, which is no easy task. For example, even a simple user request in an application triggers multiple asynchronous calls, with complex synchronization between threads, and identifying performance bottlenecks in such code requires correctly tracking causality across asynchronous boundaries. This challenging task is made even more difficult because tracing overhead is preferably kept to a minimum to avoid impact on application performance and also to limit the consumption of scarce resources such as battery and network bandwidth.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

A telemetry system, including implementation processes, is described. The telemetry system can communicate with one or more instrumented applications to collect data regarding events from the field and forward correlated and coalesced data to analytics applications for rich analysis. The telemetry system is configured to operate with event definitions having one or more schema sections for declaring and populating data from an event, which is an instantiation of the event definition. The event definition can capture actions or interactions an event author (such as the application developer) wishes to track. The disclosure also includes aspects of a system, method, and computer readable medium for use with a telemetry system that can include receiving an automatically, i.e., explicitly, populated set of fields in a schema of an event definition. The set of fields are automatically populated using a logging library. A response message is provided in an application protocol is provided.

An event definition can include multiple schema sections configured to include data from an event. In the examples, an event definition includes a first section schema having fields that are automatically populated by the logging library without input from an event author such as an application developer. For example, the first section schema can include a system schema for data that is general to all events such as system data. An event can also include a second section schema that includes fields selected by the event author. For example, a domain section schema includes fields that have broad applicability. In one example, an event author can select zero or more domain section schemas, but the event author does not control the name of the fields or the data types of the fields. Instead, the logging library predefines the fields and types in the selected domain schemas and populates the fields with data. The second section schema can further include a custom schema having fields and types defined by the event author that can be applicable to the event but not otherwise included in the system schema and the domain schema. In one example, the first section schema and the domain section schema are not defined with the event; they are common for all events.

An instrumented application can include a telemetry layer. The telemetry layer includes first section schema, or a system schema, that automatically captures common correlating data and can capture information injected with event ingestion components of a telemetry pipeline. The event author can include a second section schema that aligns with the event domain or meaning as well as create fields in a custom schema to include application-specific information related to the event.

A protocol is used to transport schema events between services in the telemetry system. In a method of the pipeline, a session is established between a client and a server using a request-response protocol. The server receives a request message in the client protocol including the payload. The server, in one example, provides a response message to the client during the session. The response includes a response code that can include an optional header field and a return object to provide information on the response code. In one example, the response code can be selected from a subset of available status codes, and the return object provided in a data-interchange format. By adhering to the protocol, multiple client implementations, service implementations, proxies, and forwarders can participate in the delivery of telemetry items in the telemetry system.

In one example, the telemetry system includes a high-volume, low latency event and telemetry platform. The telemetry system can be applied to drive one or more client and services ecosystems. Example systems or processes of the disclosure are able to unify real-time, interactive, event driven workflows from customer to cloud or computer network and back to customer with comprehensive batch telemetry. A strong common schema, with strongly-typed fixed and flexible data fields to fully describe data enables rich analysis. The systems and processes described provide for application developers to quickly and easily create new instrumentation points with relatively low overhead. The strong common schema provides for data to be efficiently collected across multiple platforms.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a block diagram illustrating an example of a computing device.

FIG. 2 is a block diagram illustrating an example telemetry system incorporating a computing device of FIG. 1.

FIG. 3 is a block diagram illustrating an example process of the telemetry system of FIG. 2.

FIG. 4 is a block diagram illustrating an example schema of the telemetry system of FIG. 2.

FIG. 5 is a block diagram illustrating an example of a response for use in the telemetry system of FIG. 2.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various exemplary embodiments described herein may be combined with each other, unless specifically noted otherwise.

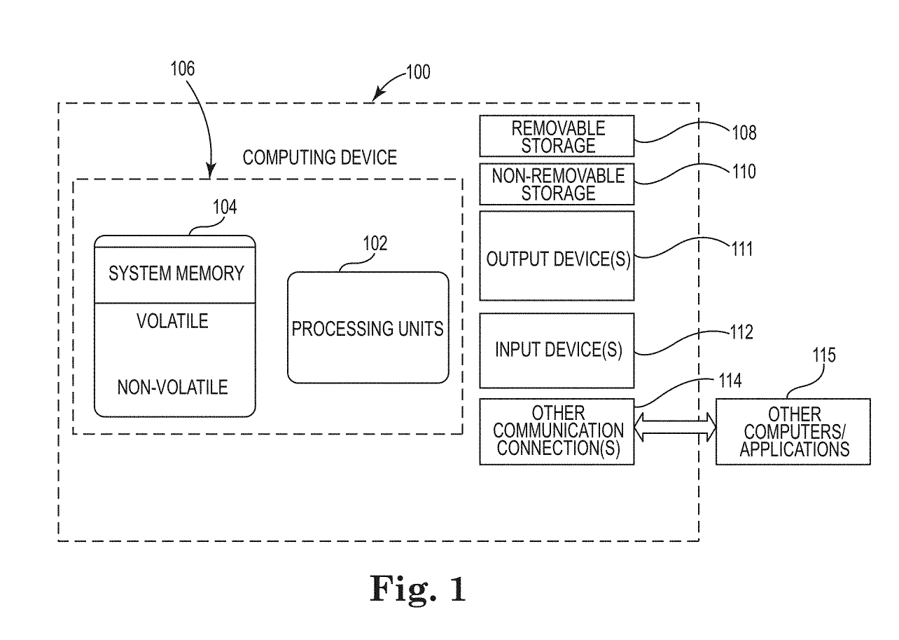

FIG. 1 illustrates an exemplary computer system that can be employed in an operating environment and used to host or run a computer application included on one or more computer readable storage mediums storing computer executable instructions for controlling the computer system, such as a computing device, to perform a process. An example of a computer-implemented process includes generation of telemetry data using a telemetry schema that can be stored in a computer memory.

The exemplary computer system includes a computing device, such as computing device 100. In a basic hardware configuration, computing device 100 typically includes a processor system having one or more processing units, i.e., processors 102, and memory 104. By way of example, the processing units may include two or more processing cores on a chip or two or more processor chips. In some examples, the computing device can also have one or more additional processing or specialized processors (not shown), such as a graphics processor for general-purpose computing on graphics processor units, to perform processing functions offloaded from the processor 102. The memory 104 may be arranged in a hierarchy and may include one or more levels of cache. Depending on the configuration and type of computing device, memory 104 may be volatile (such as random access memory (RAM)), non-volatile (such as read only memory (ROM), flash memory, etc.), or some combination of the two. The computing device 100 can take one or more of several forms. Such forms include a tablet, a personal computer, a workstation, a server, a handheld device, a consumer electronic device (such as a video game console or a digital video recorder), or other, and can be a stand-alone device or configured as part of a computer network, computer cluster, cloud services infrastructure, or other.

Computing device 100 can also have additional features or functionality. For example, computing device 100 may also include additional storage. Such storage may be removable and/or non-removable and can include magnetic or optical disks, solid-state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 100. Accordingly, a propagating signal by itself does not qualify as storage media. Any such computer storage media may be part of computing device 100.

Computing device 100 often includes one or more input and/or output connections, such as USB connections, display ports, proprietary connections, and others to connect to various devices to provide inputs and outputs to the computing device. Input devices 112 may include devices such as keyboard, pointing device (e.g., mouse), pen, voice input device, touch input device, or other. Output devices 111 may include devices such as a display, speakers, printer, or the like.

Computing device 100 often includes one or more communication connections 114 that allow computing device 100 to communicate with other computers/applications 115. Example communication connections can include an Ethernet interface, a wireless interface, a bus interface, a storage area network interface, and a proprietary interface. The communication connections can be used to couple the computing device 100 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the Internet, or other network.

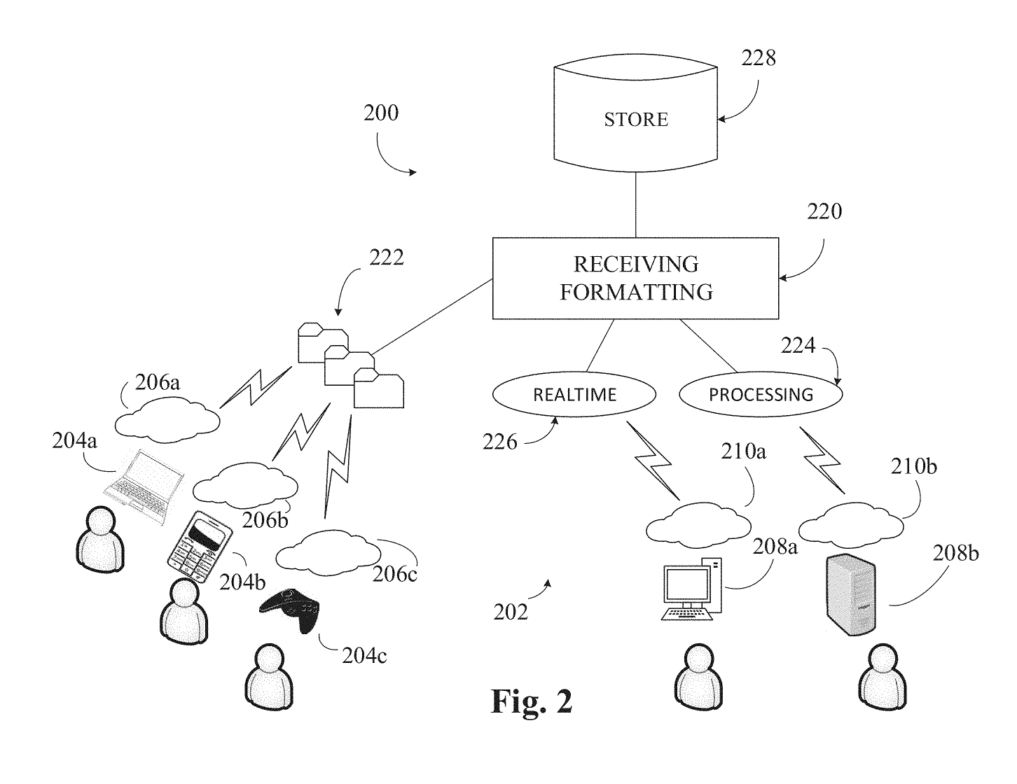

FIG. 2 illustrates an example telemetry system 200 that can include one or more computing devices, such as computing device 100, in a computer network 202. For illustration, the example telemetry system 200 can communicate with one or more client computing devices, e.g., client devices 204a-204c, executing instrumented software applications 206a-206c and can also communicate with one or more subscriber devices, e.g., subscriber computing devices 208a-208b, executing analytics software applications 210a-210b. In one example, the client devices 204a-204c and instrumented applications 206a-206c initiate communication with the telemetry system 200 over the network 202.

Instrumentation refers to augmenting an application with code that generates data that can be used to monitor or measure the performance and usage of the application, to diagnose errors, to write trace information, and the like. Programmers implement instrumentation in the form of code instructions that monitor specific components in a system. When an application contains instrumentation code, it can be managed using a management tool to review the performance of the application. Applications can be instrumented for logging and telemetry, which are typically oriented around the internal structure of the application during development and to collect data once the application is released to actual users.

Telemetry is automated remote measurement and data collection. For example, telemetry data can represent information not discoverable during application development such as which configurations customers prefer, how are customers using features in the application, what are the circumstances surrounding errors or crashes, and other information. Telemetry data can include anonymous software versioning information, resource usage, memory access, operating systems in use, and many other examples. Telemetry system 200 provides the tools to collect data and to condense the collected data into analytics, or human-decipherable reports. Telemetry system 200 also makes use of a protocol and metadata.

In some examples, the user of the instrumented applications 206a-206c can determine which telemetry information to provide to a telemetry system 200. For example, the user can select to retain particular information locally, such as personal or sensitive information, and allow other information to be provided to the analytics software application. The user can choose to not upload such information as telemetry data, and the telemetry system 200 will not have access to personal or sensitive data.

Telemetry design leads to events, or actions the instrumentation will track, and applications are typically instrumented to track a series of distinct actions of or interactions with the application. Telemetry instrumentation is provided by event authors, such as application developers or component developers, and in some examples is imposed on event handlers. In one example, an application developer may wish to track several dozen events in an application. An event definition is a description of a specific event, and includes a list of fields set forth in a contract called a schema that can provide a system for declaring and populating structured data in the example. An event includes actual instantiation of a set of data described in the event definition, and this set of data is logged and transmitted to the telemetry system 200. An event is emitted in response to selected actions or interactions, and the data payload of the event, or event payload, describes attributes and semantics about the stimulus that triggered its creation, effects of the event, or both. An event author creates the event definition and the instrumentation code to populate and transmit the event to the telemetry system 200.

Telemetry system 200 includes, for example, a receiving/formatting system 220, logging library 222, processing system 224, real-time system 226, and event store 228. Telemetry data sent by client devices 204a-204c is received at telemetry system 200, which can then forward events to subscriber devices 208a-208b with low latency. Subscribers, using analytics application 210a-210b, can declare filters to receive relevant data. Telemetry system 200 can be configured to operate with one or more schemas of declaring and populating structured or unstructured data. In one example, receiving/formatting system 220 accepts events provided by client devices 204a-204c over the Internet. Logging library 222 uploads data to the receiving/formatting system 220. Receiving/forwarding system 220 can provide data to processing system 224 for rich analytics, batch processing, and reporting. Receiving/forwarding system 220 can also, or alternatively, provide data to real-time system 226 for real-time, or near real-time, indexing, querying, monitoring, and alerting. For example, real-time system 226 can include an operational deadline from event to system response that is greater than instantaneous. Event store 228 can provide reference information about events to the telemetry system 200.

In one example, receiving/forwarding system 220 can be a web service operating on one or more servers on network 202. Telemetry system 200 can further include proxy servers and forwarders, such as Domain Name System (DNS) servers on network 202. Telemetry system 200 can include multiple client implementations and service implementations.

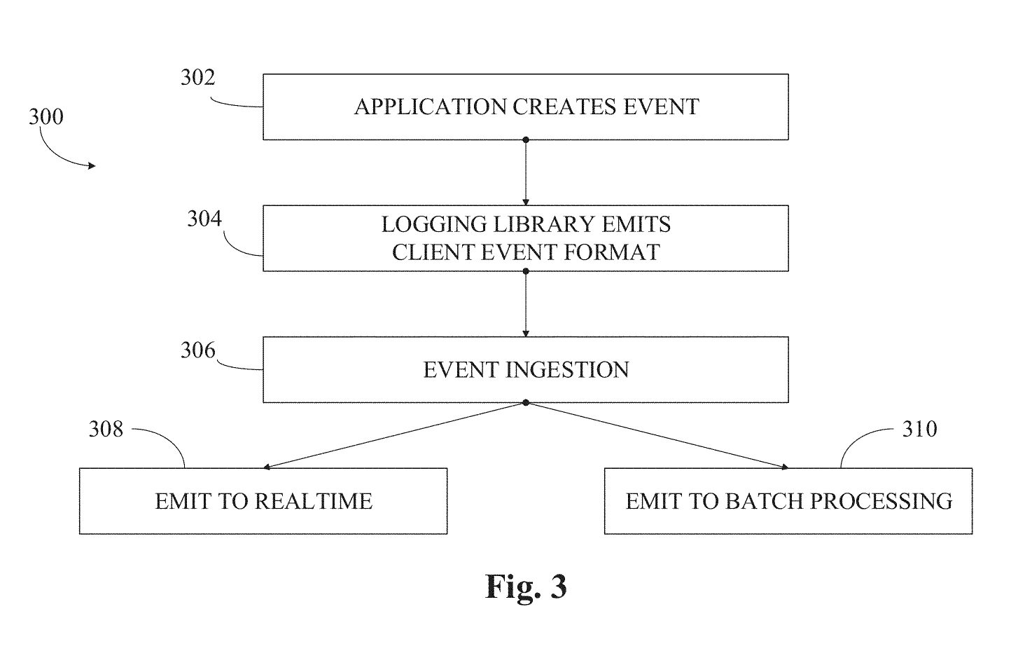

FIG. 3 illustrates a telemetry ingestion pipeline 300 to shuttle events through multiple components of the telemetry system 200. A payload can vary depending on its stage within the pipeline 300. The ingestion pipeline can be implemented as a process in one or more computing devices 100 in telemetry system 200. In the example, an instrumented software application, such as applications 206a-206c, emits an application event format to the logging library 222 at 302. Logging library 222 can include a code library that can, for example, accept an event, serialize data for transport, and upload the event to the receiving/formatting system 220. Logging library 222 can include logging libraries for multiple platforms, such as a Java logging library for the Java platform, an Android logging library for the Android platform, as well as other telemetry clients. A first section schema of an event definition includes a set of fields that are automatically populated with data using a logging library. In some examples, other aspects of the telemetry system 200 can also populate the first set of fields. The event author can select a second set of fields from another schema that are also populated in the pipeline.

Logging library 222 emits a client event format to receiving/formatting system 220 at 304. In one example, the different logging libraries dependent on platform can include a common file format to describe event definitions and a format for serialization. In one example, the format to describe event definitions can include a serialization framework for schematized data such as Bond available from Microsoft, Inc. The file format for serialization of payload can include a data-interchange format such as JavaScript Object Notation, or JSON. Additional data-interchange formats can be used such as line delimited JSON as well as binary serialization format such as a compact serialization in Bond. Receiving/formatting system 220 emits an ingested event format, at 306. Fields of the schema can continue to be populated with data at ingestion. For example, ingestion data can be provided to the first section schema to determine quality of the pipeline. Ingested events can be formatted in JSON and provided to real-time systems, at 308, or batch processing systems, at 310, for example, to allow analytical applications 210a-210b to query for data.

In one example of a method of the pipeline, a session is established between a client and server, such as between instrumented application 206a-206c and receiving/formatting system 220, using a response-request protocol. The client, such as instrumented application 206a-206c, initiates the request by establishing a transport layer protocol, such as Transmission Control Protocol (TCP), connection to a particular port on the server, such as receiving/formatting system 220. Receiving/formatting system 220 listening on the port waits for a client request message. Upon receiving the request message, the server sends back a response message indicating a status of the request and other information. Client request message includes the event packaged in an event envelope in a defined set of event sections and described in schema defined as list of fields that are composed in an event definition.

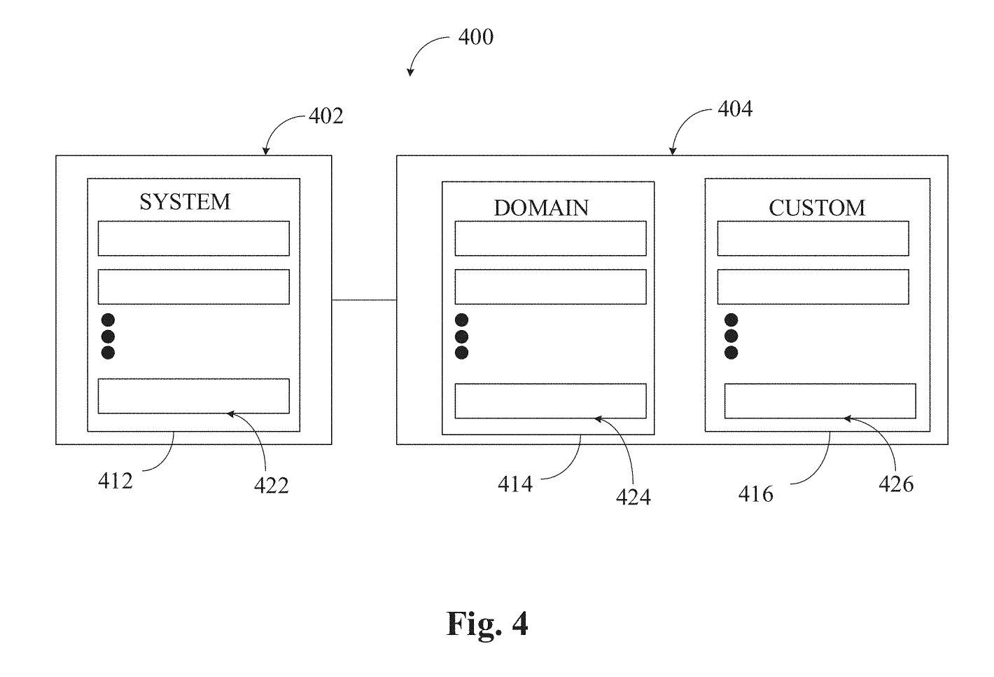

FIG. 4 illustrates an example event definition 400 for use in telemetry system 200 as a schema, or contract defining a list of fields that are composed into the event definition 400. In the example, event definition includes fields composed into multiple schema sections, referred to in the event definition 400 as a first section schema 402 and second section schema 404. The first section schema 402 in one example include system schema 412 having system fields 422, and second section fields 404 can further include multiple sections such as domain schema 414 having domain fields 424 and custom schema 416 having custom fields 426, which are described in greater detail below. In alternative examples, however, an event may include just fields from the first section 402 and can optionally include fields from the second section 404. In this example, the event definition can optionally include fields from domain schema 414, option include fields from custom schema 416, or, as indicated in event definition 400, fields from both the domain schema 414 and custom schema 416. Event definition 400 can also include annotations that might not appear in the actual event data, such as descriptions, ownership information and field data types. Further, fields can include default values.

Field definitions in the example include a name and a type. Types can include basic data types (such as Boolean, various integer types, floating point numbers, strings), containers (lists, vectors, sets, maps), as well as complex types. In one example, types can be selected from those supported in the serialization framework. Not all complex types, however, supported in the serialization framework may be supported in the data-interchange format. In such cases, complex types in the serialization format can be converted to string type.

The example of an event represented in JSON includes:

{
/ / First Section Schema (system fields)
“ver” : <Schema version>,
“name” : <Event name>”,
. . .
“data” : {

/ / Second Section Schema
“baseType” : “<Domain Section name>”,
“basedData” : {

/ / Domain Section fields
. . .

},

/ / Custom Section fields
. . .

}

}

First section schema 402 includes fields 422 defined by and automatically populated by the logging library 222 present on the local system where events are sent in the pipeline, such as in pipeline 300. In one example, first section schema 402 captures common correlating fields and can relate to the system of the instrumented software application, such as applications 206a-206c, and can represent system data. First section schema 402 can also capture information injected by event ingestion components in pipeline 300. First section schema 402 includes fields typically applicable to all events from the instrumented application, and can include items such as event time, event name, and Internet Protocol address of sender. In some examples, first section schema 402 can include fields 422 the logging library obtains from a caller in addition to values that are automatically filled. In one example, all events use the same first section schema.

First section schema 402 includes fields 422 that are universal and applied to all events that flow through the telemetry system 200, and the design of the schema 402, including the selection of the particular fields 422 to include, can be guided by various principles such as consistent identifiers across diverse applications and platforms such as operating systems as well as care taken to consider the effect on application overhead. First section schema enables correlation and is available for automatic instrumentation using the logging library 222. In one example, the first section schema 402 can include an event envelope semantic and an ingest section.

The event envelope includes a data payload used to transmit event information between components of the pipeline 300. The payload can include the original event and a defined set of event sections. The event envelope semantic can include fields 422 such as schema version, name of the event, time (including date), sample rate, sequence to track order of uploaded events, instrumentation key, flags, device identifier that can be resilient to system builds or hardware replacements, operating system, operating system versions including branch and build information, application identifier, application version, user identifier, and, in some examples, a property bag for custom logging library fields.

The ingest section can be filled at ingestion time. Fields for the ingest section can include time when event was received by the receiving/formatting system 220, the remote address seen by the receiving/formatting system 220 when the event was accepted, event authentication, and event quality.

Second section schema 404 includes optional domain schema 414, custom schema 416, or both. Second section schema 404 includes fields 424, 426 that are populated by code written by the event author rather than the logging library 222. In one example, second section schema 404 include domain schema 414 having predefined fields 424, such as defined by the telemetry system 200 or other centralized groups, and the event author does not control the name of the fields 424 or data type of the fields 424. Custom schema 416 is created by an event author and can be used for scenarios or aspects of events that are application-specific and for which no domain field 424 exists. Templates can be applied to second section schema 404 to support reuse of fields 424, 426 that are commonly defined across several events. In one example, templates are used for domain schema 414. Templates support defining a set of fields that can be consistently reused across multiple event definitions and, in some example, when multiple event definitions include different domain fields 424.

In one example, domain schema 414 is relevant to a particular scenario or aspects of events that are common across many different applications. For example, fields 424 in domain schema 414 can include logging an error, application start event, application end event, web services API (application program interface) call success, API call failure, and many other examples. A wide variety of applications and events can define events from domain schema fields 424 and thus include similar fields and data. Thus, a set of common reports and analytics can be built to consume all events from all applications on platforms that use the same domain schema 414. Event templates are analogous to abstract classes that allow, for example, a centralized group to share a set of fields that several related events include. In one example, domain fields 424 can be late-bound and chosen when the event is defined.

Domain schemas 414 are generalized to enable broad applicability. For example, a domain schema MediaUsage can exist rather than more specific domain schemas such as play song, stop song, play video, stop video, or the like, which are more specific but use a schema per media player, for example.

Custom schema 416 is created and defined by the event author. In one example, the event author can determine the name and data type of the custom fields 426. The event author is also responsible for populating the custom fields 426 when an event is instantiated. An event defined without a domain schema can be inherited from a base to give the event only custom fields 426.

A client protocol is used to transport schema events 400 between services in the telemetry system 200 that support telemetry events. Data payloads in the schema event parts 400 can be transferred between components in the pipeline 300, such as between a telemetry layer in the instrumented application 206a-206c and the receiving/formatting system 220, in a request-response protocol in a client-server model. One example of a request-response protocol for use with pipeline 300 in system 200 includes an application protocol. Examples of application protocols include hypertext transfer protocol, or HTTP, which includes sessions having request-response transactions, as well as SPDY, HTTP/2 (HTTP/2.0), WebSocket, and other protocols. In one example, the client submits an HTTP request to the server, and the telemetry items can be exchanged via HTTP having a JSON payload. The server provides a response message to the client. The response can include status information about the request.

In order to efficiently and reliably send telemetry in system 200, client protocol can include certain request constraints. Request constraints can include limits on size of the request, the number of events per request, and the size of the events. In one example, a request size can be limited to not exceed 4 MB per request, the number of events per request can be limited to not exceed five-hundred events, and the event size can be limited to not exceed 64 KB per event. In such a configuration, the request size limits the number of maximum sized events to less than the system maximum of events per request. Request constraints typically affect the number of domain fields 424 and custom fields 426 in each event.

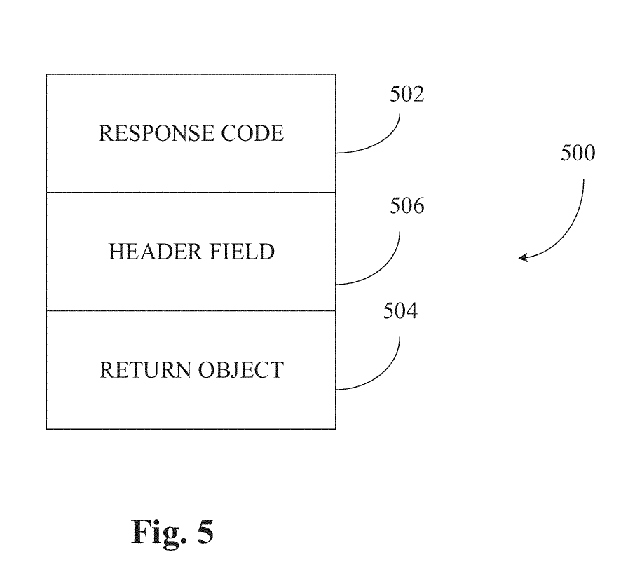

FIG. 5 illustrates a response message 500 in the client protocol generated by the server, or receiver of the telemetry item in pipeline 300. Response message 500 includes one or more response codes 502 and return objects in a return object schema 504.

Response codes 502 can be based upon a subset of available codes, such as HTTP status codes. For example, response codes can be based upon from success (2xx), client error (4xx), and server error (5xx) groups. Codes from other groups, such as informational or redirection can also be included in the client protocol as well as custom codes. Additionally, response messages can include a header field 506 in a string format in the line after response codes 502. Header fields 506 can include standard fields or user created fields based on the type of response code 502.

Success codes 2xx in response codes 502 can include “200 OK” to indicate all events in the request are accepted by the server and “206 Partial Content” to indicate some events in the request are accepted. A client receiving a 206 response code can be prompted to take an action.

Client error codes 4xx in response codes 502 include issues in the request constraints. Client error codes in response codes 502 can include “400 Bad Request” to indicate no events were accepted, “413 Request Entity Too Large,” to indicate the request size is over the size constraint, such as 4 MB. “414 Request URI Too Large” to indicate the universal resource identifier is too long, “415 Unsupported Media Type” to indicate the format of the request is not supported by the server, and “429 Too Many Requests” to indicate the client should rate limit the events. The server can include a retry-after header in field 506 after the error code 502 with either an HTTP-date or number of seconds to retry.

Server error codes 5xx in response codes 502 include issue in the server receiving the events. Server error codes in response codes 502 can include “500 Internal Server Error” to indicate the server failed and “503 Service Unavailable” to indicate the server is temporarily unavailable. In one example, a server can be temporarily unavailable due to too much network traffic. The server can include a retry-after header in field 506 after the error code 502 with either an HTTP-date or number of seconds to retry.

Response codes 502 can also include a “timeout” code if the server did not response in a selected amount of time. In one example, the “timeout” code indicates to the client to retry the request message using an exponential backoff approach such as binary exponential backoff or truncated binary exponential backoff type algorithms.

Return object schema 504 can include a plurality of fields including data to explain response codes in addition to or instead of the header field 506. The return object can be in a data-interchange format such as JSON or line delimited JSON.

For example, fields can include “rej” to indicate the number of events rejected, “acc” to indicate the number of events accepted, and an “efi” array to provide event failure information. In one example, the “efi” array includes one event failure information structure for each rejected event. The array can include an “efi.line” to indicate the line number of the rejected event. The line numbers in one example begin at zero. The array can also include fields “efi.char” that can indicate the character number of the item that failed parsing starting at zero, “efi.message” that can give a detailed description of the failure, and “efi.reason” that can include a code for reason for failure. For example, a first code, such as “3,” can be used when upload is terminated and set when an HTTP exception is encountered while reading the event stream, a second code, such as “7,” can be used to indicate excessive size and set when an event is too large, a third code, such as “8,” can be used to indicate an invalid payload format and set when the JSON, for example, for an event is invalid, and a fourth code, such as “9,” can be used when an expected data is missing and set when expected field in the event is missing.

An example return object in JSON indicating that one event of ten in the request have been rejected for missing information based on the above example fields and codes:

{

“rej”: 1,
“acc”: 9,
“efi”: [{

“line”: 4,
“char”: 0,
“reason”: 9

}]

}

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of operating a telemetry system, the method comprising:
receiving an automatically populated set of fields in a schema of an event definition, the set of fields automatically populated using a logging library of the telemetry system; and
providing a response message in an application protocol.

2. The method of claim 1 comprising:
populating a second set of fields in the schema selected by an event author.

3. The method of claim 2 wherein populating the second set of fields includes preselected fields from the telemetry system.

4. The method of claim 3 wherein the preselected fields are populated with data common to a plurality of applications.

5. The method of claim 2 wherein populating the second set of fields includes custom fields from the event author.

6. The method of claim 1 wherein the set of fields is automatically populated with data common to all events.

7. The method of claim 1 wherein the response message includes a response code and return object.

8. The method of claim 7 wherein the response message includes a header field associated with the response code.

9. The method of claim 7 wherein the response code is selected from a set of status codes.

10. The method of claim 7 wherein the return object is included in a data-interchange format.

11. The method of claim 7 wherein the application protocol is hypertext transfer protocol.

12. A telemetry system, comprising:
a computing device including a processor and a memory configured to:
receive an automatically populated a set of fields in a schema of an event definition, the set of fields automatically populated using a logging library of the telemetry system; and
provide a response message in an application protocol.

13. The telemetry system of claim 12, wherein the computing device is configured to:
populate a second set of fields in the schema selected by an event author.

14. The telemetry system of claim 12 wherein the response message includes a response code and return object.

15. The telemetry system of claim 14 wherein the response message includes a header field associated with the response code.

16. The telemetry system of claim 12 including constraints on request size, number of events, and event size in a request.

17. The telemetry system of claim 12 including proxies and forwarders.

18. A computer readable storage medium storing computer executable instructions for controlling a computing device to perform a method comprising:
receiving an automatically populated set of fields in a schema of an event definition, the set of fields automatically populated using a logging library; and
providing a response message in an application protocol.

19. The computer readable storage medium of claim 18 wherein the response message includes a response code and return object.

20. The computer readable storage medium of claim 19 wherein the return object is included in a data-interchange format.
